(19) United States
(12) Patent Application Publication
(10) Pub. No.: US 2003/0214490 A1
(43) Pub. Date: Nov. 20, 2003

(54) Stylus providing variable line width as a function of pressure

(75) Inventor: Kenneth J. Cool, Dakota Dunes, SD (US)

Correspondence Address: GATEWAY, INC., 14303 GATEWAY PLACE, ATTENTION: MARK WALKER (MAIL DROP SD-21), POWAY, CA, 92064, US

(73) Assignee: Gateway, Inc.

(21) Appl. No.: 10/151,566

(22) Filed: May 20, 2002

(51) Int. Cl. G09G 5/00

(52) U.S. Cl. 345/179

(57) ABSTRACT

A digital input stylus includes a sensor to determine pressure being applied to the stylus. The determined pressure is translated to a line thickness for display on a display device. The pressure is digitized and communicated to the display device, such as a tablet PC. Settings in the tablet PC are modifiable by a user to determine the format of the line thickness, correlating detected pressure with desired thickness.

### FIELD OF THE INVENTION

The present invention relates to drawing lines using a stylus, and in particular to the use of variable pressure to create variable line widths on a display device.

### BACKGROUND OF THE INVENTION

Handheld computers are increasing in popularity. User input of text has proven cumbersome. Some handheld computers come in the form of a tablet, and offer stylus or other pen like instruments that allow the user to write directly onto a resistance or capacitive grid of the tablet. Some such stylus have pressure sensors coupled to a tip of the stylus to detect when the stylus has come into contact with a surface. The tablet is thus notified to initiate a writing session.

In many tablets, display of the writing is not natural. In natural hand writing, the thickness of lines drawn may vary with the pressure applied to a pen or pencil. To help solve this problem, some tablets have pressure sensing devices built into the tablet itself. This can be a difficult solution because a sensor may not accurately detect pressure of a writing instrument over a large area of the tablet. Increasing the number of such sensors required to properly sense pressure over a large area results in increased cost.

### SUMMARY OF THE INVENTION

A digital input stylus includes a sensor to determine pressure being applied to the stylus. The determined pressure is translated to a line thickness for display on a display device.

In one embodiment of the invention, the stylus comprises circuitry for digitizing the determined pressure, and communicating the digitized pressure to the display device via wired or wireless interface. The digitized pressure directly corresponds to line width in one embodiment, or is further processed by the display device to determine line thickness.

The display device comprises a tablet PC in one embodiment having a processor, memory, and a resistive or capacitive grid. The stylus is used on the grid to communicate line drawing by a user. The pressure sensor is alternatively used to determine initiation of a writing session as well as communicating information about the pressure applied to the stylus by the user. Settings in the tablet PC are generated by a user to determine the format of the line thickness, correlating detected pressure with desired thickness.

### BRIEF DESCRIPTION OF THE DRAWINGS

FIG. 1 is a block perspective view of a stylus and computer in accordance with the present invention.

FIG. 2 is a flowchart indicating a process for detecting pressure and translating the pressure to a line width to display on a display device of the computer of FIG. 1.

### DETAILED DESCRIPTION OF THE INVENTION

In the following description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

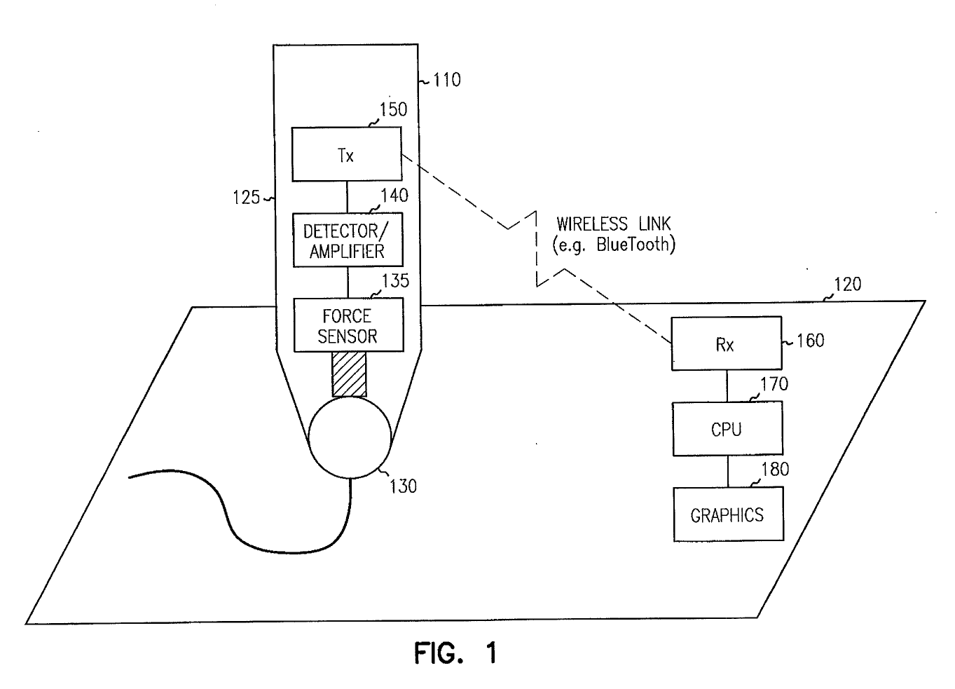

A stylus 110 in FIG. 1 is used to draw lines on a tablet type of computer 120. The tablet computer is just one example of many computer based information input and display devices. In further embodiments, the tablet 120 is simply be an input device for a separate display device or computer system. Tablet 120 comprises a resistive or capacitive grid to detect the location and movement of the stylus, which is translated to a corresponding display of a line or characters, or other drawings much in the same manner as a pen or pencil makes on a piece of paper.

Stylus 110 comprises a pen or pencil shaped body 125. Other shapes suitable for use by users to create art or text, or other types of marks are used in further embodiments. There are no limits to the types of shapes that may be used. Stylus 110 comprises a tip 130 designed for contact with tablet 120 to facilitate drawing of lines. A force sensor 135 is directly coupled or optionally coupled to the tip through further members to translate pressure applied to tip 130 by a user during drawing. The force sensor is shown in block diagram form to represent any type of pressure sensor that provides a predictable signal as a function of the pressure applied to the tip 130.

Force sensor 135 comprises a piezo electric pressure transducer known in the art in one embodiment. The force sensor 135 is tubular in shape in one embodiment, and is disposed parallel to the length of the stylus. As pressure is applied to the tip 130, it is translated back to the sensor, which compresses and uncompresses depending on the change in pressure applied to the stylus. This compression is converted to an electrical signal provided to detector amplifier 140. The detector/amplifier includes an analog to digital converter in one embodiment, and provides a digital signal to a transmitter 150 for transmission to the tablet 120. The signal is transmitted in one of many manners and protocols, such as IR or RF, using BlueTooth or other protocols.

In one embodiment, the sensor provides a linear signal representative of the force. In further embodiments, the sensor provides a non-linear, but known signal in response to the pressure. This signal is converted at some point, either by the detector amplifier 140, of by the tablet 120 to signal proportional to the pressure applied such that a line having a width corresponding to the pressure applied.

Tablet 120 receives the transmission at a receiver 160. The receiver 160 converts the received transmission to a pressure indication having a logic level or protocol suitable for a processor (CPU) 170. Processor 170 further comprises memory and programming to convert the pressure indication into a line width in accordance with settings correlating the pressure to desired line width. This is a simple numerical amplification value in one embodiment which a user modifies via a menu or other type of graphical user interface.

A graphics driver 180 receives line width information from the processor and proceeds to draw lines on a display in accordance with the line width information and sensed movement of the stylus. In one embodiment, the display and tablet 120 are integrated such that the user draws with the stylus directly on the display. In further embodiments, the tablet comprises an input device, providing further signals to a separate display or computer system.

In one embodiment of the invention, force sensor 135 is disposed within a housing of stylus 110 and may communicate writing pressure information to tablet 120 from stylus 110. For example, the writing pressure information communicated by force sensor 135 from stylus 110 to tablet 120 may include information representative of a varying amount of pressure that a user exerts on a writing surface with stylus 110 while the user executes a writing or drawing stroke or a series of writing or drawing strokes. In such an embodiment, the user may provide a characteristic and stylized writing input to tablet 120 with stylus 110. For example, writing pressure information obtained by force sensor 135 may allow a user to write in a calligraphic writing style characteristic of a writing style using a quill or a fountain pen. Other types of writing styles may include the use of a handwriting character set or ideograph where stroke width is utilized to facilitate hand printing of a desired character or ideograph. For example, the operation of force sensor 135 to provide a variable line width as a function of the pressure applied by a user with stylus 110 may facilitate a user writing in a Chinese or Japanese character set or ideograph set such as kanji, hiragana, or katakana writing. Many other writing styles or functions (e.g., handwriting character sets, cursive writing, lettering, artistic drawings, cartoon drawings, and so on) may likewise be obtained with the present invention without departing from the scope of the invention.

In a further embodiment of the invention, force sensor 135 is disposed in a stylus 110 that writes using ink applied via a tip 130 of stylus 110 to apply the ink to a writing surface.

In an alternative embodiment, force sensor is disposed in a stylus that does not provide an ink output when writing in an electronic writing capture mode. A writing surface of tablet 120 may be coincident with a display of tablet 120 such that writing on the writing surface with stylus 110 may also result in displaying of a writing output on the display. In an alternative embodiment, a writing surface upon which a user writes using stylus 110 is separate from a display of tablet 120 that may display a writing output of stylus 110. For example, stylus 110 with force sensor 135 may be utilized in a white board system that captures a writing output of stylus 110 and electronically transmits the writing output to tablet 120, which may be a personal computer or the like in communication with the white board system or the stylus 110 of the write board system.

In another embodiment, a writing output of stylus 110 is batched in a memory disposed within stylus 110 so that the writing output may be stored in stylus 110 during writing, and then later the writing output may be transferred to tablet 120 for storage or display. In one embodiment, tablet 120 may include one or more sheets of standard paper. In an alternative embodiment, tablet 120 is an input surface of a display for a computer or similar electronic device that may include a CPU 170. In another embodiment, tablet 120 may be a device that allows a user to simultaneously write on a standard sheet of paper while capturing a writing signal, optionally displaying or not displaying the writing signal on a display.

The invention may utilize one or more of several types of stylus position determining systems to determine the position of stylus 110 to provide a writing output signal in response to the position of or movement in position of stylus 110 with respect to a writing surface, and need not be limited to any one particular positioning or writing sensing system. Force information detected by force sensor 135 may be added to or superimposed upon the writing output signal of such stylus positioning determining systems, and then later received by and decoded by CPU 170. In one of many alternative embodiments, a positioning determining system may include detecting a position of stylus 110 using an optical grid of dots or other indicia arranged in a predetermined pattern on a writing surface where the grid of indicia may be used to communicate position information. In one embodiment of the invention, the indicia in the grid may be detected optically using an optical sensor disposed in stylus 110, where the indicia may be disposed on a sheet of paper, on a white board writing surface, or on a display surface, to provide stylus writing input. In another embodiment of the invention, the indicia in the grid may include a magnetic material and are magnetically detected using a sensor responsive to a magnetic field. Tablet 120 may be any type of writing surface or writing capture device, including but not limited to paper, electronic paper, white board, chalk board, input tablet, touch pad, touch screen, display, cathode ray tube, liquid crystal display, tablet PC, personal digital assistant, cell phone, television, etc., without departing from the scope of the invention.

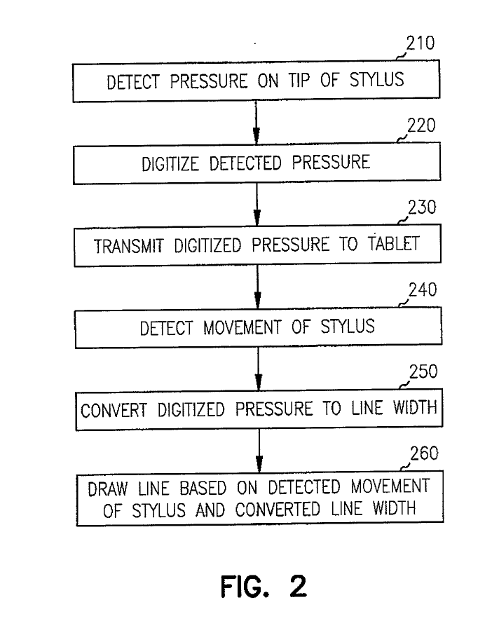

Process flow for the present invention is shown in FIG. 2. At 210, pressure is detected on the tip of the stylus as a user begins to draw. The detected pressure is digitized in one embodiment at 220. In further embodiments, an analog signal is generated, and either digitized at the tablet, or directly converted to a corresponding line width without prior digitization.

At 230, the digitized pressure is transmitted to the tablet in any one of many known manners, such as IR, RF, cable, or other type of communication mechanism. The tablet in one embodiment, detects movement of the stylus at 240 on a resistive or capacitive grid in one embodiment. In further embodiments, accelerometers directly in the stylus detect movement and transmit representations of such movement back to the tablet.

The digitized pressure is converted to a corresponding line width 250 in accordance with predetermined or user provided parameters. These parameters correspond to a font size in one embodiment, and simply help the user define the desired width of a line given pressure on the tip of the stylus. It is referred to as a sensitivity setting in a further embodiment, and is identified on a desired scale of sensitivity, such a 1 to 5, with 5 being most sensitive. Other scales may easily be incorporated as desired.

At 260, the detected movement and pressure are used to draw a line. As earlier indicated, the line is drawn directly on a display area of the tablet, or on a further display device coupled to the stylus or tablet.

The functions described herein are implemented in software in one embodiment, where the software comprises computer executable instructions stored on computer readable media such as a memory incorporated with processor 170 or other type of storage device. The term “computer readable media” is also used to represent carrier waves on which the software is transmitted.

### CONCLUSION

A digital input stylus includes a sensor to determine pressure being applied to the stylus. The determined pressure is translated to a line thickness for display on a display device. The present invention provides a system that draws a line with variable line width with the use of just one force sensor. The stylus is useable for drawing variable line widths on tablet PCs that do not have hardware designed to provide variable line width. This facilitates designs of more expensive, decorative types of stylus that are used with multiple different computers.

The stylus communicates with a display device, such as a tablet PC. Other display devices may be used. Settings in the tablet PC are modifiable by a user to determine the format of the line thickness, correlating detected pressure with desired thickness.

While a stylus has been described, the invention may be incorporated in any type of device that could be used to draw lines. Many devices exist in many different shapes, although a pen or pencil shape is most common.

What is claimed is:

1. A drawing device comprising:
a housing;
a tip positioned at one end of the housing;
a force sensor coupled to the tip to detect pressure applied by a user through the housing to the tip; and
a transmitter that transmits signals representative of a line width desired by the user based on the amount of pressure applied to the tip.

2. The drawing device of claim 1 wherein the pressure is directly proportional to the desired line width.

3. The drawing device of claim 1 and further comprising an analog to digital converter that converts an analog signals representative of pressure from the force sensor to a digital representation for transmission by the transmitter.

4. The drawing device of claim 3 wherein the digital signal is a linearized representation of desired line width.

5. The drawing device of claim 1 wherein the transmitter is a wireless transmitter.

6. The drawing device of claim 5 wherein the transmitter is one of an infrared or RF transmitter.

7. A drawing device comprising:
a housing;
a tip coupled to the housing;
a force sensor coupled to the tip to detect pressure applied by a user through the housing to the tip;
a transmitter coupled to the force sensor that transmits signals representative of the amount of pressure applied to the tip;
a grid that detects movement of the tip on the grid and provides a signal representative of the movement; and
a display that receives the pressure signal and the movement signal and displays a variable width line based on such signals.

8. The drawing device of claim 7 wherein the gird is one of a capacitive or resistive grid.

9. The drawing device of claim 7 wherein the display and grid comprise a tablet computer.

10. The drawing device of claim 9 wherein the tablet computer further comprises:
a receiver that receives pressure signals; and
a processor coupled to the receiver.

11. The drawing device of claim 7 wherein the pressure is directly proportional to the desired line width.

12. The drawing device of claim 7 and further comprising an analog to digital converter that converts an analog signals representative of pressure from the force sensor to a digital representation for transmission by the transmitter.

13. The drawing device of claim 12 wherein the digital signal is a linearized representation of desired line width.

14. The drawing device of claim 7 wherein the transmitter is a wireless transmitter.

15. The drawing device of claim 14 wherein the transmitter is one of an infrared or RF transmitter.

16. A method of drawing variable width lines with a stylus, the method comprising:
detecting pressure on the tip of a stylus;
converting the pressure to signal representative of detected pressure;
transmitting the signal to a display; and
displaying a line having a width proportional to the pressure.

17. The method of claim 16 wherein the line width is directly proportional to the pressure.

18. The method of claim 16 wherein the line width is a function of a user provided sensitivity.

19. The method of claim 16 and further comprising:
detecting movement of the tip of the stylus; and
wherein the direction of the line drawn is a function of the detected movement of the tip of the stylus.

20. The method of claim 16 and further comprising digitizing the force signal prior to transmitting it.

21. A method of drawing a variable line width on a tablet computer, the method comprising:
receiving a signal transmitted via a wireless protocol from a stylus representative of pressure applied to a tip of the stylus;
detecting movement of the tip on a grid of the tablet computer; and
displaying a variable width line responsive to the signal and detected movement.

22. An apparatus, comprising:
a stylus; and
a force sensor disposed within said stylus to provide stylus pressure information during the utilization of said stylus.

23. The apparatus of claim 22, further comprising a transmitter disposed in the stylus to transmit the stylus pressure information to a remote device.

24. The apparatus of claim 22, further comprising a memory disposed in the stylus to store the stylus pressure information.

25. The apparatus of claim 22 wherein the stylus pressure information represents a varying line width as a function of a pressure applied by a user with the stylus when the user utilizes the stylus.

26. The apparatus of claim 22, further comprising an electronic device including a processor to receive stylus pressure information from the force sensor.

27. The apparatus of claim 22, further comprising:
a transmitter disposed in the stylus to transmit the stylus pressure information;
an electronic device including a receiver to receive stylus pressure information transmitted by said transmitter; and
a processor coupled to the receiver to process the stylus pressure information.

28. The apparatus of claim 22, further comprising:
a transmitter disposed in said stylus to transmit the stylus pressure information;
an electronic device including a receiver to receive stylus pressure information transmitted by said transmitter;
a processor coupled to said receiver to process the stylus pressure information; and
a graphics device coupled to the processor to display a varying line width as a function of a pressure applied by a user with the stylus when the user utilizes the stylus.

29. An apparatus, comprising:
a housing; and
a processor disposed within the housing to process stylus pressure information received from a stylus that includes a force sensor disposed in the stylus to provide the stylus pressure information.

30. The apparatus of claim 29, further comprising a receiver disposed in said housing to receive the stylus pressure information transmitted from a transmitter disposed in the stylus.
